(19) United States
(12) Patent Application Publication
(10) Pub. No.: US 2011/0277605 A1
(43) Pub. Date: Nov. 17, 2011

(54) METHOD TO CREATE 3-DIMENSIONAL IMAGES FROM A PHOTOGRAPH

(76) Inventor: Ralph Howard Sutton, Hilton Head Island, SC (US)

(21) Appl. No.: 13/093,204

(22) Filed: Apr. 25, 2011

Related U.S. Application Data
(60) Provisional application No. 61/334,223, filed on May 13, 2010.

(51) Int. Cl. B26D 7/06

(52) U.S. Cl. 83/23

(57) ABSTRACT

This is a method to create 3-dimensional images from photographs. These images appear to make it seem like the photograph has come alive in 3-dimensions. This is a Method of combining together images produced within the process and a method of layering in 3-dimensions to create the end product 3-dimensional image which is a 3-dimensional version of the original photograph the artist used to replicate and begin the process. The end product of this method can be displayed as a free standing work of art. The end product of this method can be a matted image and/or a framed image. The end product of this method can be placed hanging from or attached to a wall or other surface, or placed on an stand like an easel or tripod for free standing on a table or floor or other surface.

“This application claims the benefit under 35 U.S.C. 119(e) of any U.S. provisional application(s) listed below. Application No. 61/334,223 Filing date May 13, 2010.”

### FIELD OF THE INVENTION

This is a method to create 3-dimensional images from photographs. These images appear to make it seem like the photograph has come alive in 3-dimensions. This is a method of combining together images produced within the process and a method of layering them one on top of another together to create the end product 3-dimensional image which is a 3-dimensional version of the original photograph the creator used to replicate and begin the process. The end product of this method can be displayed as a free standing work of art. The end product of this method can be a matted image and/or a framed image. The end product of this method can be placed hanging from or attached to a wall or other surface, or placed on an stand, like an easel or tripod, for free standing on a table or floor or other surface.

### BACKGROUND OF THE INVENTION

Many people like to buy and collect a variety of types of photographs and art. Some photographs and art are produced and duplicated for sale in quantity and some are unique one of a kind originals. Photographs and artwork are used for many purposes and in many different ways. Some people simply collect and store the photographs and/or artwork, some use these items as reminders to document and recall events, others like to display these items and show off their collections of such items, and others have a variety of uses for these items. There are many photographers, artists, manufacturers, retailers, other persons, and companies competing for the consumers business in photograph and artwork sales. These competitors are continuously experimenting to come up with new and unique ways and methods to produce works which are different and can stand out and catch the eye of the consumer.

It is desirable that a new method of creating 3-dimensional images from photographs be provided. These images appear to make it seem like the photograph has come alive in 3-dimensions so a purchaser of photographs and/or art can have new and different, original choices of types of reproduction of images and events to purchase and/or collect.

The world we see is in three dimensions. It is therefore an objective of the present invention to provide a method for creating a new and different type of reproduction of images and events that does not have the drawbacks or shortcomings of two dimensional photographs. Traditional photographs are only produced in two dimensions therefore methods for producing 3-dimensional art that appears like a 3-dimensional photograph allow for the production of images that look more alive more close to reality and unique.

It is another object of the present invention to provide a method to create 3-dimensional images from photographs which can be duplicated for quantity production and sold to consumers in quantity. It is important that when the method is used in mass production or quantity production the cost of using this method in production becomes a cost effective way of producing affordable 3-dimensional alternatives to 2-dimensional photographs for sale to consumers. Also a method that is easily performed in quantity such as this one would be preferred.

### SUMMARY OF THE INVENTION

In accordance with the present invention, this is a method to create 3-dimensional images from a photographs. These images appear to make it seem like the photograph has come alive in 3-dimensions. This is a Method of combining together duplicate photographic images produced within the process and a method of layering in 3-dimensions, and hand cutting with a blade some of the duplicate copies eliminating sections there from, eliminating from the outside in toward the center, each top layer in the process having less of the image then the previous one, as the layers are being built up, to create the end product 3-dimensional image which is a 3-dimensional version of the original photograph the artist used to replicate and begin the process. The end product of this method can be displayed as a free standing work of art. The end product of this method can be a matted image and/or a framed image. The end product of this method can be placed hanging from or attached to a wall or other surface, or placed on an stand like an easel or tripod for free standing on a table or floor or other surface.

### PREFERRED EMBODIMENT

In a preferred embodiment, the method for creating 3-dimensional images from photographs can be carried out by selecting a 2-dimensional photograph (Color or Black & White) that you would like to have re-created by this method and process, making a plurality of duplicate photograph copies of said 2-dimensional photograph (Color or Black & White); in a size you desire, and building up a 3-dimensional version from the center of a pre-selected background while eliminating sections from each duplicate photograph copy being placed on top of the pile. Eliminating from the outside of the image in toward the center, each top layer in the process having less of the image then the previous one, as the layers are being built up, to create the end product 3-dimensional image which is a 3-dimensional version of the original photograph the artist used to replicate and begin the process. By using the measuring techniques outlined in the steps of the claims below and cutting each duplicate photograph copy. Placement of the cut photograph copies on top of each other in the air space above the background mat board or mat paper in any direction there from, using layering in 3 dimensions. Then the final 3-dimensional image which is a 3-dimensional version of the original photograph the creator used to replicate and begin the process is matted and framed with glass or plastic insert.

### BRIEF DESCRIPTION OF THE DRAWINGS

The invention will now be described, by way of example, with reference to the accompanying drawings, in which:

FIG. 1a) depicts a 2-dimensional photograph (Color or Black & White).

FIG. 1b) depicts plurality of copies of said 2-dimensional photograph (Color or Black & White).

FIG. 1c) depict a background color mat board and said mat board will be cut to a desired size. FIG. 1c) also depicts the clearance on all edges of the mat board.

FIG. 2a) depicts the locating of the center of the mat board and FIG. 2b) depicts the locating of the center of said plurality of copies by measuring top to bottom and left to right or corner to corner; and providing clearance on all edges of the mat board when centering the 3-dimensional image.

FIG. 2c) depict providing various photocopies for various layers in said 3-dimensional image placing said photocopies on top of each other in layers building up 3 dimensions. The copies will be secured on top of each other each one eliminating more of the original image, usually eliminating from the exterior of the image in toward the center, and being smaller in size then the previous cut duplicate photograph copy on said mat board.

FIG. 3a) depicts said cut photocopies on top of each other each one eliminating more of the original image, and being smaller in size then the previous cut duplicate photograph copy. The copies will be secured on top of each other each one eliminating more of the original image, usually eliminating from the exterior of the image in toward the center, and being smaller in size then the previous cut photograph copy on said mat board. FIG. 3b) depicts the plurality of cut photograph copies when adhered to said mat board and the other copies using 2-sided, 1/16″ inch foam tape. FIG. 3c) depicts the final 3-dimensional image mated. FIG. 3d) depicts the final 3-dimensional image mated and framed.

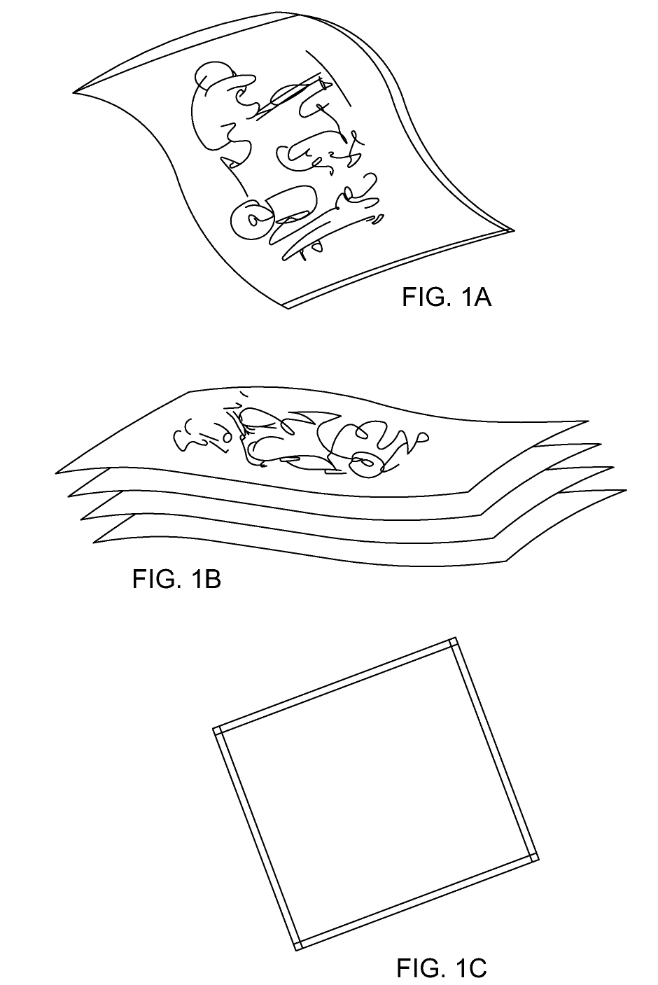

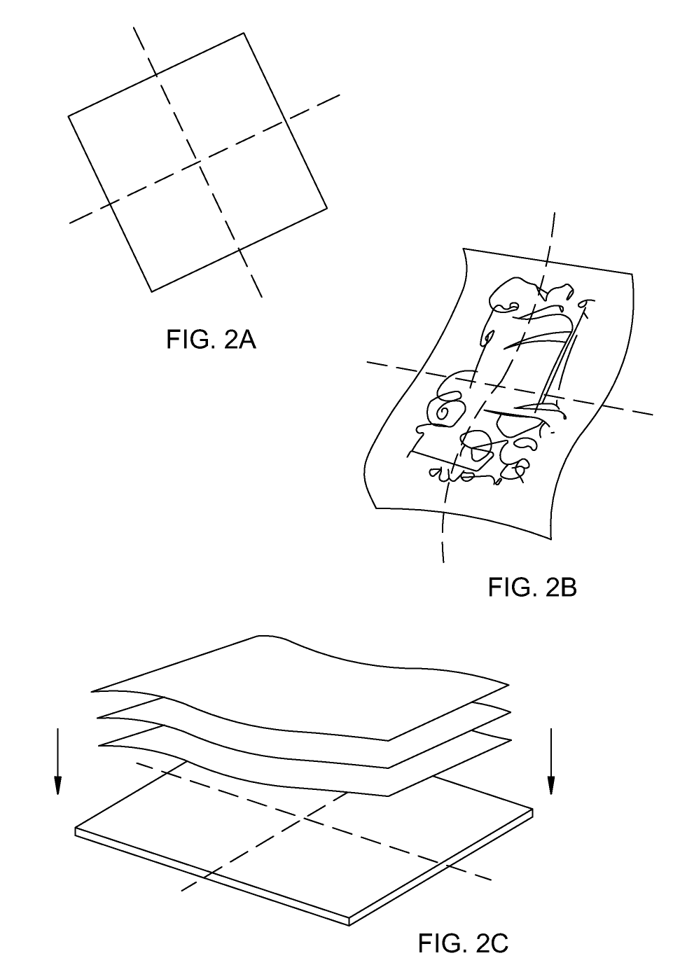

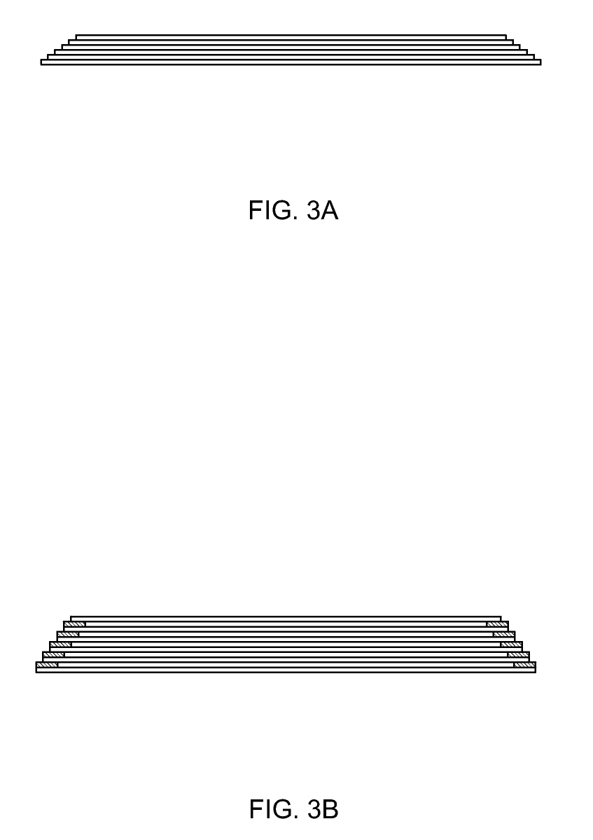

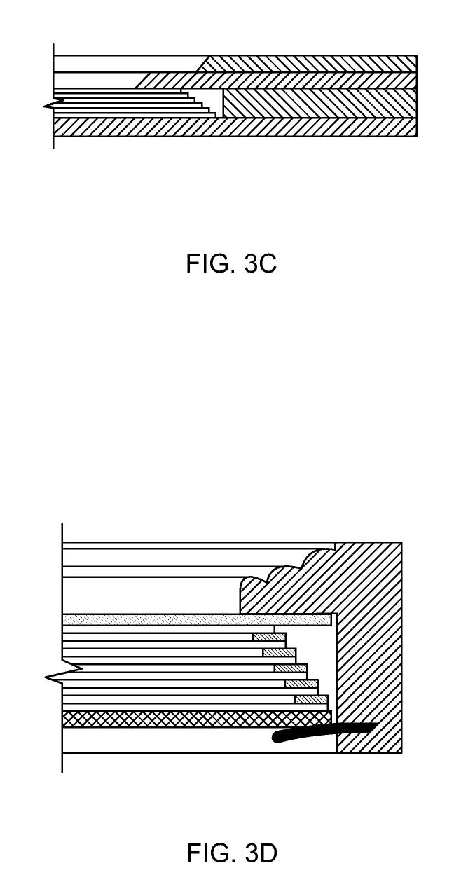

### DETAILED DESCRIPTION OF THE PREFERRED EMBODIMENT

The present invention discuses a method to create 3-dimensional images from photographs. The end product of this method can be displayed as a free standing 3-dimensional image. The end product of this method can be a matted image and/or a framed image. The end product of this method can be placed hanging from or attached to a wall or other surface, or placed on an stand like an easel or tripod for free standing on a table or floor or other surface. Many people like to buy and collect a variety of types of photographs and art. Some photographs and art are produced and duplicated for sale in quantity and some are unique one of a kind originals. Photographs and art are used for many purposes and in many different ways. Some people simply collect and store the photographs and/or art, some use these items to document and recall events, others like to display them and show off their collections, and others have a variety of uses for these items. There are many photographers, artists, manufacturers, retailers, other persons, and companies competing for the consumers business in photograph and artwork sales. These competitors are continuously experimenting to come up with new and unique ways and methods to produce works which are different and can stand out and catch the eye of the consumer. In a preferred embodiment, the method for creating 3-dimensional images from photographs can be carried out by selecting a photograph that you would like to have created by this 3-dimensional method, making copies of the photograph in a size you desire, and building up and out a 3-d version from the center of a pre-selected background. By using the techniques outlined in the steps of the claims below. Then the final 3-dimensional image which is a 3-dimensional version of the original photograph the artist used to replicate and begin the process is matted and framed with glass or plastic insert.

The present invention method can be carried out by the following steps. First:

a) The Creator that will be creating the new piece of artwork will choose a 2-dimensional photograph;

b) The Creator will then make a plurality of duplicate photograph copies of said 2-dimensional photograph.

c) Which process may include the shrinking or enlarging of the image onto the photograph duplicates or copies being created as needed. The photograph copies could be all Black and White, or they can all be Color duplicates or Copies, or they can be a combination of both black and white and color copies. The photograph copies can also be comprised of at least #20 pound white paper, or can be comprised of at least #28 pound white paper. The number of copies can comprise of not more than 12 duplicate photograph copies.

c) The Creator will then provide a background color mat board and cut the said mat board to a desired size. and locate the center of the mat board and said plurality of copies by measuring top to bottom and left to right or corner to corner. The Creator can also adhere to the mat board a 2-dimenional photograph copy or other background design on a paper as background for the 3-dimensional image being created in this process and method.

d). The Creator can then provide clearance room on all edges of the mat board when centering the 3-dimensional image and providing various photocopies of various sizes for various layers in said 3-dimenstional image.

e) The Creator then places said photocopies on top of each other in layers building up 3 dimensions, each new top copy eliminating more sections and/or parts from the photograph copy then the last top copy or layer, eliminating the parts or sections of the image starting from the exterior of the image and moving in toward the center, and working on the image by working outward and forward from the mat board and backround to the last image copy placed on the top appearing to be in the front of the last image having been placed behind it. Repeating the process of selecting a new top copy and eliminating more sections and/or parts from this selected photograph copy then the last top copy or layer and placing and securing this copy on top of the last one that was placed on top until the copies have all been cut and secured in place.

f) The completed 3-dimensional photograph image which is a 3-dimensional version of the original photograph the creator used to replicate and begin the process upon completion is then mated and/or mated and framed or framed under glass, acrylic, or plastic.

1) Authentication can be achieved through signing and/or dating the work, numbering the work, as well as other techniques.

m) The mat board used can be required to have at least a thickness of 1/16″ of an inch.

n) The photocopies can be adhered to said mat board and/or other copies using 2-sided, 1/16″ inch foam tape and the foam tape is semi-aggressive, the said foam tape increase the depth of said 3-dimensional image and places distance and space between the photograph copies or layers.

o) A blade is used to cut the mat board and duplicate photograph copies. The copies described in this invention as being produced in the process and method can be photocopies of the original 2-dimensional photograph and/or photographs and/or photograph reproductions of the identical image and 2-dimensional photograph.

While the preferred embodiments of the invention have been described above, it will be recognized and understood that various modifications can be made in the invention and the appended claims are intended to cover all such modifications which may fall within the spirit and scope of the invention.

1. A method of creating 3-dimensional images from a 2-dimensional photograph comprising the steps of:
a) providing a 2-dimensional photograph;
b) making a plurality of duplicate copies of said 2-dimensional photograph;
c) providing a background color mat board;
d) cutting said mat board to a desired size;
e) locating the center of the mat board and said plurality of duplicate copies by measuring top to bottom and left to right or corner to corner;
(f) providing clearance on all edges of the mat board when centering the 3-dimensional image;
g) providing various duplicate copies of the original photograph for various layers in said 3-dimensional image;
i) selecting a first duplicate copy from the said plurality of copies;
j) securing this first duplicate copy to the mat board;
k) selecting a next duplicate copy;
l) cutting the next duplicate photograph copy to eliminate sections and parts of the image from said selected copy that appear on the previous copy that was previously selected and secured to the mat;
m) placing and securing said selected copy on top of the previously selected copy thereby building up layers of copies to create 3 dimensions;
n) Continuing to select a next duplicate copy from the said plurality of copies and cutting the next photograph copy to eliminate sections and parts of the image from said copy that appear on the previously cut copy, placing and securing said copy on top of the previously cut and secured copy thereby building up layers to obtain a 3-dimensional image;
o) selecting the last free standing photograph copy from the said plurality of copies and cutting the final duplicate photograph copy to eliminate sections and parts of the image from said copy that appear on the previously cut copy, placing and securing said copy on top of the previously cut and secured copy thereby building up layers and creating the 3-dimensional image.

2. The method for creating 3-dimensioinal images from a 2-dimensional photograph according to claim 1, wherein said step of making a plurality of duplicate photograph copies comprises shrinking or enlarging said photograph image.

3. The method for creating 3-dimensional images from a 2-dimensional photograph according to claim 1, wherein said plurality of photograph copies comprises at least #20 pound white paper.

4. The method for creating 3-dimensional images from a 2-dimensional photograph according to claim 1, wherein said plurality of photograph copies comprises at least #28 pound white paper.

5. The method for creating 3-dimensional images from a 2-dimensional photograph according to claim 1, wherein said plurality of photograph copies comprises a maximum of 12 duplicate photograph copies.

6. The method for creating 3-dimensional images from a 2-dimensional photograph according to claim 1, further comprising a 2-dimensional photograph copy or other background design on a paper and adhering said 2-dimensional photograph copy or other background design on a paper to said mat board as a background for the 3-dimensional image to be placed upon.

7. The method for creating 3-dimensional images from a 2-dimensional photograph according to claim 1, wherein said mat board has a thickness of at least 1/16″ of an inch.

8. The method for creating 3-dimensional images from a 2-dimensional photograph according to claim 1, wherein said plurality of cut photograph copies are adhered to said mat board using 2-sided, 1/16″ inch foam tape.

9. The method for creating 3-dimensional images from a 2-dimensional photograph according to claim 1, wherein said plurality of cut photograph copies are adhered to each other using 2-sided, 1/16″ inch foam tape.

10. The method for creating 3-dimensional images from a 2-dimensional photograph according to claim 8, wherein said foam tape is semi-aggressive.

11. The method for creating 3-dimensional images from a 2-dimensional photograph according to claim 8, wherein said foam tape increases the depth of said 3-dimensional photographs.

12. The method for creating 3-dimensional images from a 2-dimensional photograph according to claim 9, wherein said foam tape is semi-aggressive.

13. The method for creating 3-dimensional images from a 2-dimensional photograph according to claim 9, wherein said foam tape increases the depth of said 3-dimensional photographs.

14. The method for creating 3-dimensional images from a 2-dimensional photograph according to claim 1, wherein said 3-dimensional image is mated.

15. The method for creating 3-dimensional images from a 2-dimensional photograph according to claim 14, further comprising framing said 3-dimensional image.

16. The method for creating 3-dimensional images from a 2-dimensional photograph according to claim 15, wherein said 3-dimensional image is framed under glass.

17. The method for creating 3-dimensional images from a 2-dimensional photograph according to claim 15, wherein said 3-dimensional image is framed under acrylic.

18. The method for creating 3-dimensional images from a 2-dimensional photograph according to claim 1, wherein said 3-dimensional image comprises an authentication.

19. The method for creating 3-dimensional images from a 2-dimensional photograph according to claim 18, wherein said authentication comprises a signature.

20. The method for creating 3-dimensional images from a 2-dimensional photograph according to claim 1, wherein the duplicate photo copies that are cut are hand cut using a blade.

21. The method for creating 3-dimensional images from a 2-dimensional photograph according to claim 1, wherein the photo copies that are cut are cut starting from the exterior of the image and moving in toward the center.
